(19) United States
(12) Patent Application Publication
(10) Pub. No.: US 2004/0216355 A1
(43) Pub. Date: Nov. 4, 2004

(54) Fish attractor

(76) Inventor: Romy Jo Gore, Terrell, TX (US)

Correspondence Address: BRUCE E. WEIR, 12 SPARROW VALLEY COURT, MONTGOMERY VILLAGE, MD, 20886-1265, US

(21) Appl. No.: 10/856,866

(22) Filed: Jun. 1, 2004

Related U.S. Application Data
(63) Continuation of application No. 10/249,166, filed on Mar. 19, 2003.

(51) Int. Cl. A01K 75/02

(52) U.S. Cl. 43/17.5

(57) ABSTRACT

A modular fish attractor with sectional components that can be used individually or connected in many different combinations. Interchangeable attractive elements within components include light-emitting diodes, chemoluminescent capsules, solenoids, vibrating motors, and electrical potential differences produced by single-pole sources.

### CROSS-REFERENCE TO RELATED APPLICATION

This application is a continuation of application Ser. No. 10/249,166, filed Mar. 19, 2003 for Fish Attractor. This application hereby incorporates by reference the above-referenced patent application in its entirety.

### BACKGROUND AND SUMMARY

Fishermen have known since antiquity that they can increase their catch by attracting fish to the vicinity of a lure or bait. The need to attract fish from a distance becomes especially acute when fishing in still, murky water where fish may not be able to see a lure or smell bait until it is very near.

Observation of fish behavior has revealed that fish rely on and respond to a variety of sensory cues. For example, fish may respond to odiferous bait. Also, it has long been known in the art that fish are attracted to light sources. Commercial fisherman may use floodlights to attract fish to nets. Individual fishermen have adapted more compact floodlights for use on small boats. However, floodlights are bulky, awkward, consume considerable energy, and are illegal in some circumstances. Moreover, with the advent of very small batteries and low-wattage light sources, fisherman have found that fish are attracted to very small, low-intensity lights that are submerged in a fishing area.

Field observation and research have revealed that fish respond to sensory inputs beyond those of sight and smell. It is known that fish may respond to sound in the form of compression waves produced by a vibration source. Such a source may be as simple as a submerged mechanical buzzer or as complex as an electronic device programmed to reproduce specific prey sounds. However, many such devices currently known in the art share the defects of being cumbersome, unreliable, expensive, and/or difficult to adapt to changing conditions.

In addition to sight, smell, and vibration, fish also detect and respond to electrical potentials in surrounding water. When a voltage difference is created between submerged electrodes, fish have been observed to orient themselves and swim toward an anode. A sufficiently powerful electrical discharge can direct fish to an area and stun or even kill them. The practice of electrofishing relies on such energy discharges. But as with floodlights, electrofishing gear is bulky, awkward, consumes considerable energy, is illegal in some circumstances, and is in addition dangerous to the user and can be destructive both to fishing equipment and non-commercial fish species.

An individual fisherman can obtain satisfactory results with far lower energy discharges. It is known that some predatory fish can locate prey by sensing the electrical discharges of fleeing prey or, in some cases, even find tiny prey hiding under sand or other obstructions that would preclude detection by sight, smell, or vibration. The potentials so detected may be only fractions of a volt.

Some fishing lures have exploited this electrical sense by incorporating anode/cathode pairs exposed to the surrounding water and powered by batteries, piezoelectric devices, or even solar panels. Each has drawbacks: solar panels tend to be cumbersome and require light, piezoelectric devices require motion, and batteries can be heavy and short-lived. Since field experiments indicate that fish are attracted to an exposed electrode even when the electrode of opposite polarity is insulated from the surrounding environment, the current drain on a battery created by an exposed anode/cathode pair can be minimized by exposing only one electrode. A single-pole attractor allows the effective use of very compact, light batteries for extended periods of time.

The present invention mitigates the drawbacks of known attraction devices by providing a simple, compact, inexpensive, reusable, self-contained single-pole fish attractor that can be quickly reconfigured to include a variety of light and vibration-emitting attraction devices as fishing conditions dictate. The present invention can be planted on the submerged bottom of a fishing area or attached to a line near bait or a lure. The present invention can be positively or negatively buoyant, functioning as a weight or bobber as needed. When the invention is configured to include a light source, the invention can be positioned to illuminate nearby bait or a lure.

A typical embodiment of the present invention is a cylindrical acrylic rod section drilled and machined to create either one internal cavity opening to one end of the rod, or two internal cavities, each opening to an opposite end of the rod. The rod has a threaded connector at one or both ends. At least one cavity contains a single-pole source of low-voltage electrical potential. Conductive eyelets on the ends of the rod provide attachment points for fishing line and may function as electrodes. In addition, the cavity or cavities may be loaded with a variety of interchangeable attractive devices such as light-emitting diodes, chemoluminescent capsules, solenoids, and vibrating motors. Sections used individually can be sealed with watertight end caps. Sections may also be screwed together end-to-end to form many combinations of attractive elements.

A section is typically loaded with whichever attractive devices are deemed best for current conditions, the cavities are sealed with caps or adjoining sections, the section is attached to a fishing line, and the section is lowered into a fishing area and suspended at a desired depth. The fisherman is then free to employ any suitable fishing technique to catch fish drawn by the attractive elements.

All of these features and advantages of the present invention, and more, are illustrated below in the drawings and detailed description that follows.

### BRIEF DESCRIPTION OF THE DRAWINGS

FIG. 1 shows a fish attractor cross-section including an LED, a battery, and a single-pole source.

FIG. 2 shows an upper end cap section with a conductive core.

FIG. 3 shows a fish attractor cross-section including an LED, a battery, and a single-pole source.

FIG. 4 shows an upper end cap section.

FIG. 5 shows a fish attractor cross-section including an LED, a battery, and a single-pole source.

FIG. 6 a fish attractor cross-section including a chemoluminescent capsule, a battery, and a single-pole source.

FIG. 7 shows a cross-section of an upper end cap section with a conductive core.

FIG. 8 shows a fish attractor cross-section including an LED, a battery, two single-pole sources, and upper and lower sectional connectors.

FIG. 9 shows a cross-section of an upper end cap section with a conductive core.

FIG. 10 shows a cross-section of a lower end cap section.

FIG. 11 shows a fish attractor cross-section including a vibrating motor, a magnetically-driven vibration source, a battery, two single-pole sources, and upper and lower sectional connectors.

FIG. 12 shows a fish attractor cross-section including an LED, a battery, a vibrating motor, a magnetically-driven vibration source, and a single-pole source.

FIG. 13a shows a cross-section of a compression switch.

FIG. 13b shows a cross-section of an alternate embodiment of a compression switch.

FIG. 14 shows a cross-section of a vibrating motor assembly with an eccentric weight.

FIG. 15 shows a cross-section of a vibrating motor assembly with an eccentric weight and an LED.

FIG. 16 shows a cross-section of a vibration element containing magnetic balls.

FIG. 17 shows a top view of a vibration element containing magnetic balls.

FIG. 18 shows a cross-section of a vibration element containing magnetic balls held apart by a magnetic disk.

FIG. 19 shows a top view of a vibration element containing a magnetic balls held apart by a magnetic disk.

### DETAILED DESCRIPTION OF THE INVENTION

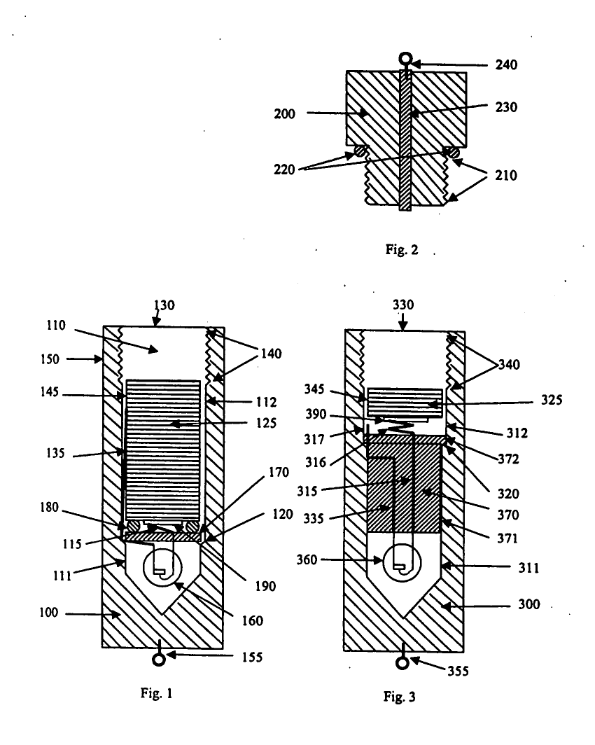

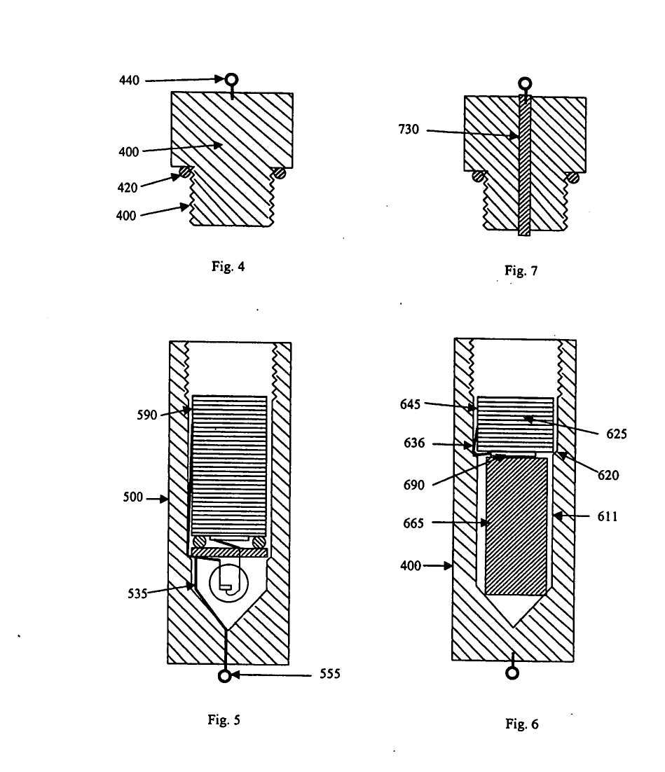

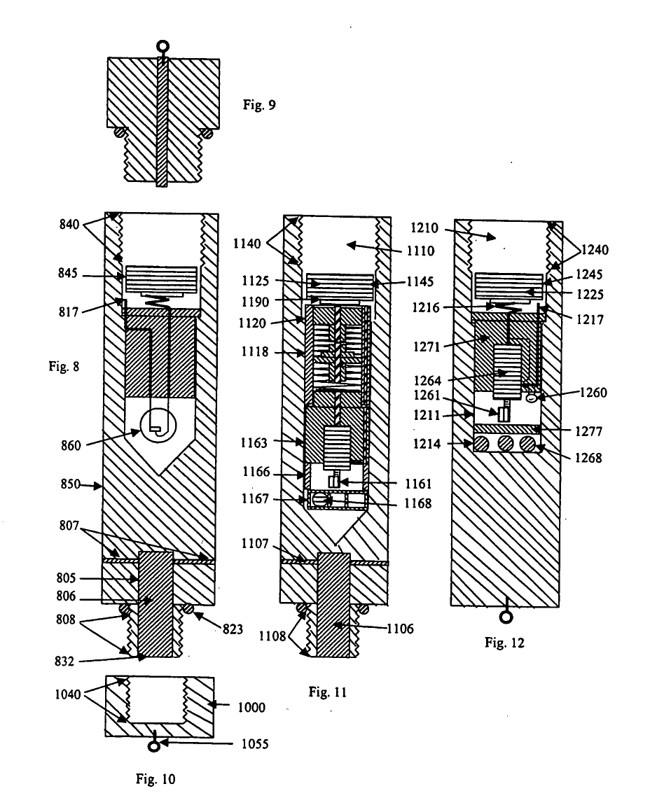

FIG. 1 shows a section of a preferred embodiment of the present invention. A housing 100 can be made of waterproof, electrically-resistive materials such plastic, glass, ceramic, or other waterproof, electrically-resistive materials suitable for casting, forming, or machining that are known in the art. A light-transmitting material allows use of an internal light-emitting attraction device. A preferred material is a transparent acrylic plastic rod, which can be center-drilled to decreasing diameters to create an interior cavity 110 with a shoulder 120 dividing a small-diameter portion 111 from a large-diameter portion 112. The cavity has an opening 130 and is tapped just inside the opening 130 to create a female threaded portion 140. The threads may alternatively be cut or formed into the exterior surface 150. Most components subsequently inserted within the interior cavity 110 would also have a circular cross-section, but square, rectangular, and many other cross-sectional shapes may be utilized.

light-emitting diode (LED) 160 or other low-wattage illumination device is mounted on a non-conductive spacer 170 which is too large to pass into the small-diameter portion 111 of the interior cavity and which rests against the shoulder 120. A compressible O-ring 180 holds a battery cathode 190 apart from the spacer 170 and a battery cathode contact 115. A battery 125 rests within the large-diameter portion 112 against the O-ring 180, with a battery anode contact 135 connecting the battery anode 145 to the LED 160. The battery 125 may be any of a variety of cells, such as a Sanyo CR-1/3N manganese oxide-lithium or similar cell as commonly used in small photographic and electronic devices. Any suitable number of batteries may be used to achieve a desired voltage and configuration. An optional lower eyelet 155 may be provided for attachment of a line or leader. The LED 160 may be exchanged for LEDs or other light sources of different colors as may be deemed desirable for current water conditions or the type of fish sought.

FIG. 2 shows a second section of a preferred embodiment of the present invention. This section functions in part as an end cap for the housing 100. A body 200 has a male threaded portion 210 proportioned to mate with the female threaded portion 140 shown in FIG. 1. The body 200 is typically made of the same non-conductive material as the housing 100. A conductor 230 passes completely through the body 200 with an upper eyelet 240 attached to or forming the upper end of the conductor 230. In alternative embodiments, the body 200 may be made of conductive material, eliminating the need for the conductor 230. In alternative embodiments, bayonet, flange, or other connection methods may be used between sections or end caps.

When the male threaded portion 210 of the body 200 is screwed completely into the opening 130 of the housing 100, an O-ring 220 seats around the opening 130 to seal the interior cavity portions 140, 112, 111 from the external environment. The battery 125 is forced downward, compressing the O-ring 180 and causing the battery cathode 190 to contact the battery cathode contact 115, energizing the LED 160 and producing an electrical potential at the exposed end of conductor 230, thereby creating both an electrical potential attraction source and a light-emitting attraction source. Gaskets and other sealing devices may be substituted for the O-ring 220.

If the upper eyelet 240 is conductive, it may also have the same potential, as may any attached conductive leader. The potential usually does not exceed positive or negative 0.75 volt. This potential may be controlled by selection of a diode, resistor, and other components. The circuit may also or instead be controlled by other switch configurations located within the interior cavity. Positive or negative buoyancy can be selected by choosing suitable materials and components, and by increasing or decreasing the overall volume of the interior cavity or cavities.

In use, the sealed and activated fish attractor comprising the attached sections shown in FIGS. 1 and 2 would typically be suspended from a fishing line attached to the upper eyelet 240, then lowered into a fishing area to a depth appropriate for the environmental conditions and type of fish sought. Another line might be attached to the lower eyelet 155 to suspend bait, a lure, and/or another fish attractor at a lower depth. The fisherman may also use a separate fishing rig to catch fish attracted to the vicinity of the fish attractor.

FIG. 3 shows an alternative embodiment of the present invention, configured to accommodate a smaller battery 325. The characteristics of the housing 300 are the same as those of the housing 100 in FIG. 1, except that the large-diameter portion 312 is shorter than the large-diameter portion 112 shown in FIG. 1 and the small-diameter portion 311 is correspondingly longer than the small-diameter portion 111 shown in FIG. 1. The additional length of the small-diameter portion 311 is filled by an elongated spacer consisting of an elongated spacer body 371 sized to fit the small-diameter portion 311 and a lip 372 sized to fit the large-diameter portion 312 and rest against a shoulder 320. A battery cathode contact 315 passes from an LED 360, which is mounted on the elongated spacer body 371, through the elongated spacer body 371 and terminates in a coil 316. A battery anode contact 335 passes from the LED 360 through the elongated spacer body 371 and terminates in a post 317. In an alternative embodiment, a flat ring is substituted for the post 317.

The battery cathode 390 remains in contact at all times with the coil 316. When the male threaded portion 210 of the body 200 is screwed completely into the opening 330, the O-ring 220 seats around the opening 330 to seal the interior cavity portions 340, 312, 311 from the external environment. The battery 325 is forced downward, compressing the coil 316 and causing the battery anode 345 to contact the post 317, energizing the LED 360. Positive or negative buoyancy can be selected by choosing suitable materials and components, and by increasing or decreasing the overall volume of the interior cavity. The elongated spacer body 371, lip 372 and the LED 360 may be exchanged as a unit to install an LED of a different color or with different electrical properties.

The battery 325 may be any of a variety of cells, such as a Sanyo CR-1/3N manganese oxide-lithium or similar cell as commonly used in small photographic and electronic devices. Any suitable number of batteries may be used to achieve a desired voltage and configuration. An optional lower eyelet 355 may be provided for attachment of a line or leader.

FIG. 4 shows a section comprising an O-ring 420, a male threaded portion 410, an eyelet 440, and a body 400 that is the same as the body 200 in FIG. 2 in all respects except that no conductor is present. The body-400 screws into the housing 500 shown in FIG. 5 in the same manner as the body 200 shown in FIG. 2 screws into the housing 100 shown in FIG. 1. The components shown in FIG. 5 are identical to and function identically to those shown in FIG. 1, except that unlike the section shown in FIG. 1, the section shown in FIG. 5 has a battery anode conductor 535 that connects the battery anode 590 to the lower eyelet 555, eliminating the need for the conductor 230 shown in FIG. 2. The body 200 in FIG. 2 could be used with the housing 500 shown in FIG. 5.

FIG. 6 shows a housing 600 that is essentially identical to the housing 300 shown in FIG. 3. Unlike the section shown in FIG. 3, however, the section shown in FIG. 6 utilizes a chemoluminescent capsule 665 in a small-diameter portion 611 to produce light. Such capsules are known in the art and may be replaced with each use. A battery 625 rests against a shoulder 620 and has an impedance element 636 connected between a battery cathode 690 and a battery anode 645, providing a desired voltage drop. The impedance element 636 may be a diode, resistor, or other suitable component as is known in the art. FIG. 7 shows a section identical to the section shown in FIG. 2. The section shown in FIG. 7 screws into the section shown in FIG. 6, with the conductor 230 connecting a battery anode 645 to the outside environment.

FIG. 8 shows a section of a preferred embodiment of the present invention. The upper part of the embodiment shown in FIG. 8 is identical to the embodiment shown in FIG. 3. However, the lower part has a second interior cavity 805 filled by a branching conductor 806 and extending through a male threaded portion 808 to extend from a second opening 832. The conductor branches 807 emerge from the exterior surface 850 of the section at as many points as deemed desirable. An O-ring 823 provides a seal when the section shown in FIG. 8 is screwed into another section. In an alternative embodiment, a flat ring is substituted for the post 817.

The section shown in FIG. 9 is identical to the section shown in FIG. 2 and functions in the same manner when screwed into the female threaded portion 840 to connect the battery anode 845 to the environment and to the post 817 to energize the LED 860. The section shown in FIG. 10 functions as a bottom end cap when the section shown in FIG. 8 is used alone. A body 1000 can be made of plastic, glass, ceramic, metal, or other waterproof materials suitable for casting, forming, or machining. A female threaded portion 1040 is sized to mate with the male threaded portion 808 shown in FIG. 8. An optional eyelet 1055 provides an attachment point for fishing line or other components.

FIG. 11 shows another section of a preferred embodiment of the present invention. The section shown in FIG. 11 is generally identical to the section shown in FIG. 8 except that the first interior cavity 1110 has been elongated to accommodate a compression switch 1118 and a vibration source that includes a motor assembly 1163, a sleeve 1166, and a vibration element 1167. In an alternative embodiment the sleeve 1166 could be integral with the vibration element 1167. In still another embodiment the sleeve 1166 could be eliminated and the motor assembly 1163 could rest against a shoulder (not shown) positioned to separate the motor assembly 1163 and the vibration element 1167.

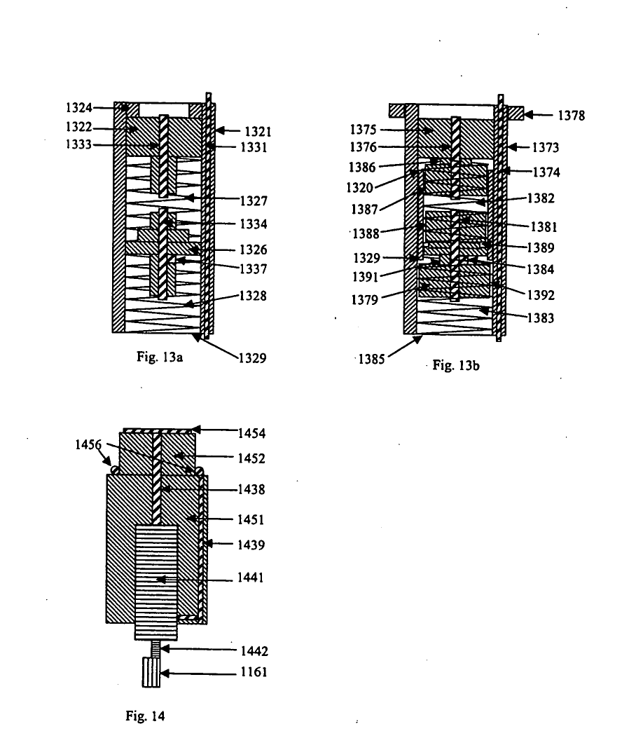

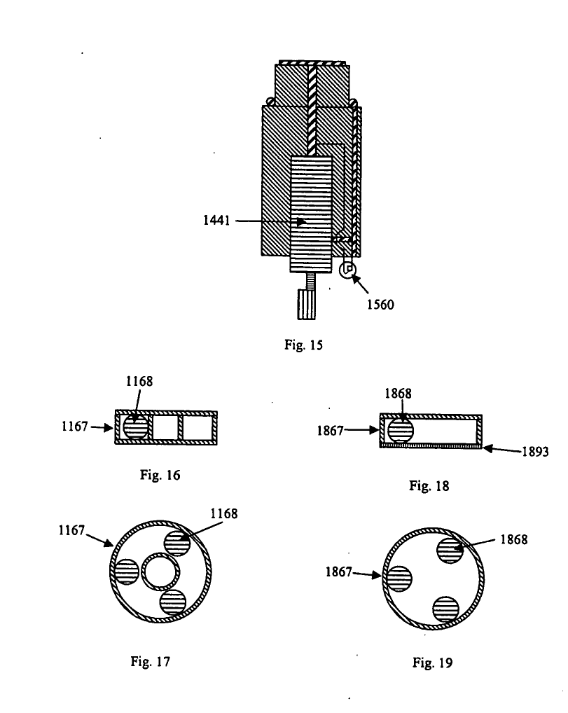

The compression switch 1118 depicted in FIG. 11 is shown in greater detail in FIG. 13a. As shown in FIG. 11, the compression switch may slide freely within the first interior cavity 1110. In an alternative embodiment of the compression switch 1118 shown in FIG. 13b, the compression switch 1118 may have a lip 1378 (not shown in FIG. 11) that rests against a shoulder 1120. The motor assembly 1163 is shown in greater detail in FIG. 14. The vibration element 1167 is shown in greater detail in FIGS. 16 and 17, with an alternative vibration element 1867 shown in FIGS. 18 and 19. In an alternate embodiment of the section shown in FIG. 11, the motor assembly shown in FIG. 14 may be exchanged for the motor assembly shown in FIG. 15, which is identical to the assembly in FIG. 14 except for the addition of an LED.

If the section shown in FIG. 11 is to be used alone it can be sealed with the sections shown in FIGS. 9 and 10 in the same manner as the section shown in FIG. 8. Alternatively, the male threaded portion 808 shown in FIG. 8 can be screwed into the female threaded portion. 1140 shown in FIG. 11, sealing the first interior cavity 1110 and compressing the battery 1125, forcing a battery pole 1190 against the compression switch 1118. The compression switch 1118 in turn compresses the motor assembly 1163, the sleeve 1166, and the vibration element 1167, thereby closing the compression switch 1118, energizing the motor assembly 1163 and creating an electrical potential attraction source. The motor assembly 1163 then causes an eccentric weight 1161 to rotate, producing a vibration in the motor assembly 1163. The vibration is transmitted throughout the fish attractor, creating sound in the form of compression waves in the surrounding medium.

In the embodiment shown, the eccentric weight 1161 is a permanent magnet that moves a magnetic ball 1168 within the vibration element 1167, producing vibrations of different frequencies. In an alternative embodiment, the vibration element 1167 may be eliminated and the section shown in FIG. 11 may rely on the motor assembly 1163 and eccentric weight 1161 to cause vibration. In an another embodiment, a solenoid vibration source as is known in the art may be used. In still another embodiment, any of a number of spring-powered or other non-electrical vibration sources known in the art may be used. The many possible vibration sources used in the present invention are interchangeable and easily installed. A specific vibration element may be selected for its ability to mimic prey species or simply to create an attractive anomaly that fish are impelled to investigate.

Screwing the male threaded portion 808 shown in FIG. 8 into the female threaded portion 1140 shown in FIG. 11 also causes the branching conductor 806 shown in FIG. 8 to contact the battery anode 1145 shown in FIG. 11, thereby inducing an electrical potential in the conductor branches 807 shown in FIG. 8. The threaded male portion 808 shown in FIG. 8 may be sealed with the end cap shown in FIG. 10.

FIG. 12 shows another section of a preferred embodiment of the present invention. The section shown in FIG. 12 has the same characteristics as the section shown in FIG. 3, except that a divider 1277 has been added to the small diameter portion 1211 to create a chamber 1214 with a magnetic ball 1268, and a motor 1264 with an eccentric weight 1261 have been added to an elongated spacer body 1271 to create a combined vibration/LED attraction element. The chamber 1214 may contain more than one magnetic ball 1268 or other objects. When either the male threaded portion 808 shown in FIG. 8 or the male threaded portion 1108 shown in FIG. 11 is screwed into the female threaded portion 1240 shown in FIG. 12, the first interior cavity 1210 is sealed and the battery 1225 and the coil 1216 are compressed, causing the battery anode 1245 to contact the post 1217, energizing the LED 1260 and the motor 1264. In an alternative embodiment, a flat ring is substituted for the post 1217.

The motor 1264 then causes the eccentric weight 1261 to rotate, producing a vibration in the elongated spacer body 1271. In the embodiment shown, the eccentric weight 1261 is a permanent magnet that moves a magnetic ball 1268 within the chamber 1214, producing vibrations of different frequencies. In an alternate embodiment, the divider 1277 and the magnetic ball 1268 may be eliminated and the section shown in FIG. 12 may rely on the motor 1264 and the eccentric weight 1261 to cause vibration. Screwing the male threaded portion 808 shown in FIG. 8 or the male threaded portion 1108 shown in FIG. 11 into the female threaded portion 1240 shown in FIG. 12 also causes the branching conductor 806 shown in FIG. 8 or the branching conductor 1106 shown in FIG. 11 to contact the battery anode 1245 shown in FIG. 12, thereby inducing an electrical potential in the conductor branches 807 shown in FIG. 8 or the conductor branches 1107 shown in FIG. 11, respectively.

FIG. 13a shows an enlarged cross-section of the compression switch 1118 shown in FIG. 11. A sleeve 1321 is open at both ends and has a positive conductor 1331 embedded along its length and protruding slightly from each end. A plug 1322 has an upper negative conductor 1333 embedded in its core and protruding slightly from each end. The plug 1322 slides freely within the sleeve 1321 but is retained by retaining ring 1324. A bi-plug 1326 also slides freely within the sleeve 1321 and has a lower negative conductor 1334 embedded in its core. An upper compression spring 1327 forces the plug 1322 and the bi-plug 1326 apart. A lower compression spring 1328 exerts opposing pressure against the bi-plug 1326, so that the bi-plug 1326 receives pressure from both directions. A negative spring contact 1337 creates a conduction path between the lower negative conductor 1334 and the lower compression spring 1328. The walls surrounding the lower opening 1329 of the sleeve 1321 may optionally be internally threaded to accept and retain an insert. In a preferred embodiment of the compression switch 1118 the sleeve 1321 and its internal components are cylindrical, but other cross-sectional shapes may be preferred and used for specific applications.

FIG. 13b shows an alternate embodiment of the compression switch shown in FIGS. 11 and 13a. A sleeve 1373 is open at both ends and has a positive conductor 1374 embedded along its length and protruding slightly from each end. A lip 1378 surrounds and may be positioned anywhere along the length of the exterior surface of the sleeve 1373. A plug 1375 has an upper negative conductor 1376 embedded in its core and protruding slightly from each end. The plug 1375 slides freely within the upper portion of the sleeve 1373 but cannot slide downward past an upper shoulder 1320. A bi-plug 1379 slides freely within the lower portion of sleeve 1373 but cannot slide upward past a lower shoulder 1329. The bi-plug 1379 has a lower negative conductor 1381 embedded in its core. An upper compression spring 1382 forces the plug 1375 and the bi-plug 1379 apart a limited distance while retaining the plug 1375 and bi-plug 1379 within the sleeve 1373. The upper end of the upper compression spring 1382 is retained by a retaining groove 1386 in the plug 1375. The lower end of the upper compression spring 1382 is retained by an upper retaining groove 1389 in the bi-plug 1379. In an alternate embodiment, the upper end of the upper compression spring 1382 may be retained by a friction fit with a lower portion 1387 of the plug 1375, while the lower end of the upper compression spring 1382 may be retained by a friction fit with an upper portion 1388 of the bi-plug 1379.

A lower compression spring 1383 exerts opposing pressure against the bi-plug 1379, so that the bi-plug 1379 receives pressure from both directions. A negative spring contact 1384 creates a conduction path between the lower negative conductor 1381 and the lower compression spring 1383. The upper end of the lower compression spring 1383 is retained by a lower retaining groove 1391 in the bi-plug 1379. In an alternative embodiment, the upper end of the lower compression spring 1383 may be retained by a friction fit with a lower portion 1392 of the bi-plug 1379. The walls surrounding the lower opening 1385 of the sleeve 1373 may optionally be internally threaded to accept and retain an insert. In a preferred embodiment of the compression switch 1118 the sleeve 1373 and its internal components are cylindrical, but other cross-sectional shapes may be preferred and used for specific applications. The polarities of the conductors may be reversed if circumstances warrant.

The compression switch is designed to rest within an interior cavity between any combination of attractive components. When a section containing a compression switch is sealed with a cap or another section, a component at one end of the compression switch presses the component's positive post (usually a ring) against the compression switch's positive conductor 1331, 1374, and the component's negative conductor against the compression switch's upper negative conductor 1333, 1376. Another attractive component similarly presses against the opposite end of the switch, forcing the switch's upper negative conductor 1333, 1376 against its lower negative conductor 1334, 1381, thereby closing the switch and energizing the components. This switch design is interchangeable with other components and easily installed in any section, replacing O-rings that are difficult to handle and easily lost while maintaining low-resistance connections between components without damaging the components with excessive pressure.

FIG. 14 shows an enlarged cross-section of the motor assembly 1163 and the eccentric weight 1161 shown in FIG. 11. A low-wattage DC electric motor 1441 is mounted in a motor sleeve 1451 that has a reduced-diameter insert portion 1452. The reduced-diameter insert portion 1452 may optionally be externally threaded to screw into the lower opening 1329 shown in FIG. 13a or the lower opening 1385 shown in FIG. 13b. A negative conductor 1438 terminates in a plate 1454 that substantially covers the end of the reduced-diameter insert portion 1452. A positive conductor 1439 terminates in a conductive ring 1456 that surrounds the base of the reduced-diameter insert portion 1452. The motor 1441 has a drive shaft 1442 protruding from its lower end, with an eccentric weight 1161 mounted on the lower end.

When the reduced-diameter insert portion 1452 is inserted or screwed into the lower opening 1329 shown in FIG. 13a and the section is assembled as shown in FIG. 11, pressure on the battery 1125 forces battery cathode 1190 into contact with the upper negative conductor 1333, which is forced into contact with the lower negative conductor 1334, which is forced into contact with the plate 1454. The battery anode 1145 is also forced into contact with the positive conductor 1331, which is forced into contact with the conductive ring 1456, energizing the motor 1441. The structure shown in FIG. 13b operates in the same manner, with the reduced-diameter insert portion 1452 inserted or screwed into the lower opening 1385 shown in FIG. 13b, and pressure on the battery 1125 forcing battery cathode 1190 into contact with the upper negative conductor 1376, which is forced into contact with the lower negative conductor 1381, which is forced into contact with the plate 1454. The battery anode 1145 is also forced into contact with the positive conductor 1376, which is forced into contact with the conductive ring 1456, energizing the motor 1441.

FIG. 15 shows an enlarged cross-section of an alternate embodiment of the motor assembly 1163 shown in FIG. 11. The motor assembly shown in FIG. 15 is essentially the same as that shown in FIG. 14, except for the addition of an LED 1560 that is energized simultaneously with the motor 1441.

FIG. 16 shows an enlarged cross-section of the vibration element 1167 shown in FIG. 11. FIG. 17 shows an enlarged top view of the vibration element 1167 shown in FIG. 11. The vibration element 1167 is a hollow ring containing one or more unattached objects, at least one of which is a ball 1168 that can be attracted or repelled by the eccentric weight 1161 (not shown in FIG. 16 or FIG. 17), thereby forced to roll around the vibration element 1167 to create vibrations.

FIG. 18 shows an enlarged cross-section of an alternate embodiment of the vibration element 1167 shown in FIG. 11. FIG. 19 shows an enlarged top view of the same alternate embodiment. The vibration element 1867 shown in FIG. 18 is a hollow cylindrical section containing one or more unattached objects, at least one of which is a ball 1868 that can be attracted or repelled by the eccentric weight 1161 (not shown in FIG. 18 or FIG. 19), thereby forced to roll around the vibration element 1867 to create vibrations. The ball 1868 comprises two magnets bonded or encased together so that the exterior surface of the ball presents either two north or two south poles. A magnetic disk 1893 forms the lower surface of the vibration element 1867 and is oriented so that its surface nearest the ball 1868 presents a pole that opposes that of the ball 1868, forcing the ball 1868 outward against the inner surface of the vibration element 1867. When more than one magnetic object is present within the vibration element 1867, the magnetic objects will have the same magnetic polarity as each other but the polarity opposite that of the magnetic disk 1893, so that the objects are forced outward against the inner surface of the vibration element 1867 and will remain equidistant.

The vibrations emanating from the vibration elements shown in FIGS. 16, 17, 18, and 19 can be modified by irregularities in an inner surface of the vibration element, the objects within the vibration element, and/or variations in the speed of the motor 1441. For example, the objects may be aspherical, or be dimpled like a golf ball. The vibrations may be constant or pulsed by control circuitry as is well-known in the art. All of the vibration sources disclosed herein cause the outer surfaces of the fish attractor to produce compression waves, or sound, in the surrounding aquatic environment, thereby attracting the attention of fish even in dark or murky water. The vibration element may have a polygonal or irregular cross-section.

Generally, the attraction sources disclosed herein are configured to be interchangeable, so that they may be used in any combination and order within a section. Electric potential and light sources may be constant or pulsed by control circuitry as is well-known in the art, to simulate bait fish activity or simply to create an attractive anomaly. A section can be made with interior cavity sizes of any practical length, so that any number of different attraction sources may be used within that section. Further, any number of separate sections may be combined to produce an attractor with optimum characteristics for a given environment and mode of fishing.

Although the attraction sources disclosed may be used alone with beneficial effect, a particularly effect method of employing the present invention is to exploit the tendency of many fish to stay near the thermocline (temperature discontinuity) that tends to form in many bodies of water. The user suspends at least two fish attractor sections at different levels, optimally above and below the thermocline. At least one section would contain a single-pole electrical potential source. Each section might also contain a light or vibration source. The sections would preferentially be suspended from different lines, but could be suspended from the same line if necessary. Once the fish attractor sections are activated and positioned the user may use organic bait on a hook or artificial lures as are known in the art to catch fish attracted to the vicinity.

Three fish attractor sections can be used to attract fish from a still wider area. The sections are suspended from separate lines, one section Just below the surface, another at mid-depth, and a third at or near the bottom. Each section has an electrical potential attraction element. The section near the surface might contain a white or blue light source to simulate and attract bait fish such as minnows and shad. The mid-depth section contains a light source and a vibration source. The bottom section contains a light source to attract bottom-dwelling fish. As previously described, once the fish attractor are activated and positioned the user may use conventional bait or artificial lures fish attracted to the vicinity.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

1. A fish attractor, comprising:
a body, the body having an exterior surface;
a voltage source, the voltage source being disposed within the body, the voltage source having an anode and a cathode, the cathode being electrically insulated from the exterior surface; and
an electrical conductor, the electrical conductor electrically connected to the anode and completely penetrating the exterior surface to electrically connect the electrical conductor to water surrounding the body.

2. A fish attractor, comprising:
a first section, the first section having a first exterior surface and at least a first interior cavity, the first interior cavity intersecting the first exterior surface to form at least a first opening;
a second section, the second section having a second exterior surface, the second section being attachable to the first section so as to cover the first opening, the attached first and second sections being submersible in water;
a voltage source, the voltage source being disposed within the first interior cavity, the voltage source having an anode and a cathode, the cathode being electrically insulated from water surrounding the attached first and second sections; and
at least a first electrical conductor, the first electrical conductor electrically connecting the anode to water surrounding the attached first and second sections.

3. A fish attractor as recited in claim 2, wherein the first electrical conductor electrically connects the anode to water surrounding the attached first and second sections by completely penetrating the first exterior surface.

4. A fish attractor as recited in claim 2, wherein the first electrical conductor electrically connects the anode to water surrounding the attached first and second sections by completely penetrating the second exterior surface.

5. A fish attractor as recited in claim 2, further comprising: a first seal, the first seal surrounding the first opening and disposed between the first section and the second section so as to form a watertight closure.

6. A fish attractor as recited in claim 2, wherein the first section comprises a material having high electrical resistivity.

7. A fish attractor as recited in claim 2, wherein the second section comprises a material having high electrical resistivity.

8. A fish attractor as recited in claim 2, wherein the fish attractor is positively buoyant.

9. A fish attractor as recited in claim 2, wherein the fish attractor is negatively buoyant.

10. A fish attractor as recited in claim 2, wherein the first section comprises a material that transmits light.

11. A fish attractor as recited in claim 10, further comprising: a light source, the light-source being disposed within the first interior cavity.

12. A fish attractor as recited in claim 11, wherein the light source is a light-emitting diode.

13. A fish attractor as recited in claim 11, wherein the light source produces light from a chemical reaction.

14. A fish attractor as recited in claim 2, wherein the voltage source comprises at least one battery.

15. A fish attractor as recited in claim 11, further comprising: a switch, the switch being disposed within the first cavity, the light source being electrically connected to the voltage source through the switch.

16. A fish attractor as recited in claim 15, wherein the switch is closed when compressed.

17. A fish attractor as recited in claim 16, further comprising:
a first threaded portion, the first threaded portion being part of the first section, the first threaded portion surrounding the first opening;
a first seal, the first seal surrounding the first opening, the first seal being disposed between the first section and the second section so as to form a watertight closure; and
a second threaded portion, the second threaded portion being part of the second section, the second threaded portion mating to the first threaded portion so as to compress the first seal and to compress the switch, the switch closing an electrical circuit between the light source and voltage source when compressed.

18. A fish attractor as recited in claim 2, further comprising: a vibration source, the vibration source being disposed within the first interior cavity.

19. A fish attractor as recited in claim 18, wherein the vibration source comprises:
an electric motor, the electric motor having a rotatable shaft; and
a weight, the weight eccentrically mounted upon the shaft so as to induce the motor to vibrate when the shaft rotates.

20. A fish attractor as recited in claim 18, wherein the vibration source comprises:
an electric motor, the electric motor having a rotatable shaft;
a magnet, the magnet mounted on the shaft; and
at least a first vibration-inducing object, the first vibration-inducing object comprising material capable of being moved by magnetic force, the first vibration-inducing object inducing vibration within the first section by moving in response to rotation of the shaft.

21. A fish attractor as recited in claim 18, wherein the vibration source comprises a solenoid.

22. A fish attractor as recited in claim 18, further comprising: a switch, the switch being disposed within the first interior cavity, the vibration source being electrically connected to the voltage source through the switch.

23. A fish attractor as recited in claim 22, wherein the switch is closed when compressed.

24. A fish attractor as recited in claim 23, further comprising:
a first threaded portion, the first threaded portion being part of the first section, the first threaded portion surrounding the first opening;
a first seal, the first seal surrounding the first opening, the first seal being disposed between the first section and the second section so as to form a watertight closure; and
a second threaded portion, the second threaded portion being part of the second section, the second threaded portion mating to the first threaded portion so as to compress the first seal and to compress the switch, the switch closing an electrical circuit between the vibration source and voltage source when compressed.

25-47. (cancelled)
